(19) United States
(12) Patent Application Publication
(10) Pub. No.: US 2007/0177517 A1
(43) Pub. Date: Aug. 2, 2007

(54) COMMUNICATION SYSTEM, COMMUNICATION APPARATUS, AND COMMUNICATION QUALITY TEST METHOD

(75) Inventor: Masao MANABE, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: NEC ELECTRONICS CORPORATION, Kanagawa (JP)

(21) Appl. No.: 11/620,305

(22) Filed: Jan. 5, 2007

(30) Foreign Application Priority Data
Jan. 27, 2006 (JP) 2006-018841

(51) Int. Cl. H04J 3/14

(52) U.S. Cl. 370/248; 370/389

(57) ABSTRACT

A communication system according to the present invention includes a first communication apparatus and a second communication apparatus. The first communication apparatus includes a test data generation unit, a packet generation unit and a transmitter unit. The test data generation unit is configured to generate test data. The packet generation unit is configured to having a payload and an error check data in response to a test packet transfer request. The payload contains the test data generated by the test data generation unit. The error check data is used to detecting a digital error occurred in the payload. The transmitter unit is configured to send the test packet. The second communication apparatus is configured to send the test packet transfer request to the first communication apparatus, and to verify quality of the test packet received from the first communication apparatus according to the error check data.

### BACKGROUND OF THE INVENTION

1. Field of the Invention

The present invention relates to a communication system including a mechanism for performing a communication quality test.

2. Description of Related Art

The WUSB (Wireless Universal Serial Bus) specification Rev. 1.0 is disclosed by USB-IF (USB Implementers Forum) in May 2005. This specification is hereinafter referred to as the WUSB specification.

In a WUSB communication system, a WUSB host and a WUSB device are connected by a radio link. Generally radio communication is known to have lower communication quality than wired communication. Accordingly the WUSB specification specifies to find an error by a digital error occurred in the radio link between the WUSB host and the WUSB device. Furthermore, various parameters for a data transfer between the WUSB host and the WUSB device can be changed depending on an incidence rate of the error. The parameters include a maximum packet length and a maximum number of bursts, a bit rate of transfer data, and transmit power etc. The WUSB specification employs a burst transfer mode that enables a continuous transmission of a plurality of data packets in a data phase of one transaction group. The burst transfer mode is referred to as a burst mode. The maximum number of bursts is a maximum value of transferable packets in a data phase of one transaction group while employing the burst mode.

The WUSB specification requires the WUSB device to support following two control requests, which are a loopback data write request and a loopback data read request. The communication quality of the radio link can be examined using the two control requests.

To examine communication quality of a direction from the WUSB host to the WUSB device (hereinafter referred to as an OUT direction), the loopback data write request is issued from the WUSB host to the WUSB device in a token phase of a WUSB transaction. In a data phase following the token phase, a data packet with a payload including test data is transferred from the WUSB host to the WUSB device. The WUSB device once received the data packet, verifies whether the digital error exists by referring to a frame check sequence (FCS) appended to the data packet. If not detecting the digital error, the WUSB device stores the test data included in the payload of the received data packet to a memory and also notifies a successful reception of the test packet to the WUSB host by a handshake packet that is sent in a handshake phase.

On the other hand if detecting the digital error by referring to the FCS, the WUSB device discards the received data packet and also notifies an unsuccessful reception of the test packet to the WUSB host by the handshake packet that is sent in the handshake phase. The WUSB host is able to know whether the digital error is generated in the data transfer of the OUT direction by the handshake packet received from the WUSB device. Therefore, by repeating the loopback data write request, the WUSB host is able to estimate a rate of the digital error in the OUT direction.

To examine communication quality of a direction from the WUSB device to the WUSB host (hereinafter referred to as an IN direction), which is an opposite direction to the OUT direction, the loopback data write request and the loopback data read request are used. The WUSB host firstly issues the loopback data write request to provide the WUSB device with the test data. Subsequently the WUSB host issues the loopback data read request. The WUSB device once received the loopback data read request, reads out the test data stored to the memory, generates a data packet with a payload having the test data, and then sends the data packet to the WUSB host. The WUSB host verifies whether a digital error exists in the data transfer of the IN direction by referring to the FCS of the data packet received from the WUSB device. Therefore, by repeating the loopback data read request after the loopback data write request, the WUSB host is able to know a rate of digital error in the IN direction.

As described in the foregoing, the WUSB communication system can examine the communication quality for estimating the rate of digital error in the OUT and the IN directions. Based on the result of the examination, the parameters such as the maximum packet length may be determined in the WUSB host.

There are following related technologies besides the above technology. A digital radio communication apparatus for determining a packet size of transfer data depending on a digital error rate of data received from an opposing communication apparatus is disclosed in Japanese Unexamined Patent Application Publication No. 11-355253.

In a communication apparatus for retransferring packets when the opposing communication apparatus detects the digital error occurred in received data, a technology for estimating the rate of digital error according to the packet length of a transfer packet and the number of the packet retransfers so as to adjust the packet length of a transfer packet is disclosed in Japanese Unexamined Patent Application Publication No. 63-304745.

Further, a radio communication apparatus for sending a pseudo random pattern as data for measuring the rate of digital error to the opposing communication apparatus is disclosed in Japanese Unexamined Patent Application Publication No. 2002-300361.

As described in the foregoing, to examine the communication quality of the IN direction, the WUSB communication system complying with the WUSB specification requires to process the loopback data write request and the WUSB host to provide the test data in advance to the WUSB device. It has now been discovered that in the conventional WUSB system, a redundant transaction for providing the test data to the WUSB device is required.

This problem is not limited to the WUSB communication system but applied to communication systems having two communication systems for sending and receiving data each other, one of the communication apparatus requiring another to send test data, and the communication system examining communication quality by verifying the digital error occurred in the returned test data.

### SUMMARY OF THE INVENTION

According to the present invention, there is provided a communication system that includes a first communication apparatus and a second communication apparatus. The first communication apparatus includes a test data generation unit, a packet generation unit and a transmitter unit. The test data generation unit is configured to generate test data. The packet generation unit is configured to having a payload and an error check data in response to a test packet transfer request. The payload contains the test data generated by the test data generation unit. The error check data is used to detecting a digital error occurred in the payload. The transmitter unit is configured to send the test packet. The second communication apparatus is configured to send the test packet transfer request to the first communication apparatus, and to verify quality of the test packet received from the first communication apparatus according to the error check data.

According to another aspect of the present invention, there is provided a communication apparatus that includes a test data generation unit being configured to generate test data, a packet generation unit being configured to generate a test packet having a payload and a error check data in response to a test packet transfer request received from an opposing communication apparatus, and a transmitter unit being configured to send the test packet to the opposing communication apparatus. The payload contains the test data generated by the test data generation unit. The error check data is used to detecting a digital error occurred in the payload.

According to another aspect of the present invention, there is provided a method for examining communication quality between a first communication apparatus having a test data generation unit configured to generate test data and a second communication apparatus configured to send and receive data with the first communication apparatus. Specifically the second communication apparatus sends a test packet transfer request to the first communication apparatus. Then the first communication apparatus sends a test packet to the second communication apparatus according to the test packet transfer request received from the second communication apparatus, the test packet having a payload including the test data generated by the test data generation unit and the test packet having error check data detectable of a digital error occurred in the payload. Then the second communication apparatus verifies whether a digital error exists in the received test packet according to the error check data.

In the communication system of the present invention, the examination of the communication quality of a direction from the first to the second communication apparatus is performed by the first communication apparatus generating the test packet in response to the test packet transfer request from the second communication apparatus, and sending the test packet to the second communication apparatus.

Accordingly as the first communication apparatus itself generates the test data, it is not necessary to provide the test data from the second communication apparatus that requests to send the test packet to the first communication apparatus. Thus, supposing that the first communication apparatus is a WUSB device and the second communication apparatus is a WUSB host, it is possible to suppress from generating a redundant transaction for the WUSB host to provide the test data to the WUSB device.

In the communication apparatus of the present invention, the communication apparatus itself generates the test data, it is not necessary to provide the test data from the opposing communication apparatus that requests to send the test packet to the communication apparatus of this invention. Thus, supposing that the communication apparatus of the present invention is the WUSB device and the opposing communication apparatus is the WUSB host, it is possible to suppress from generating a redundant transaction for the WUSB host to provide the test data to the WUSB device.

Further, by the method for examining communication quality of the present invention, it is possible to examine communication quality of a direction from the first to the second communication apparatus without providing the test data from the second communication apparatus that requests to send the test packet to the first communication apparatus. Therefore, a redundant transaction for providing the test data in advance from the second to the first communication apparatus is not required.

### BRIEF DESCRIPTION OF THE DRAWINGS

The above and other objects, advantages and features of the present invention will be more apparent from the following description taken in conjunction with the accompanying drawings, in which:

FIG. 1 is a configuration diagram of a WUSB communication system according to an embodiment of the present invention;

FIG. 2 is a configuration diagram of a WUSB device according to an embodiment of the present invention;

FIG. 3 is a flowchart illustrating an operation of the WUSB device according to an embodiment of the present invention;

FIG. 4 is a view illustrating a format of a test packet transfer request according to an embodiment of the present invention;

FIG. 5 is a view illustrating a view of a WUSB data packet according to an embodiment of the present invention;

FIG. 6 is a view illustrating a format of a test packet transfer request according to an embodiment of the present invention; and

FIG. 7 is a flowchart illustrating an operation of a WUSB device according to an embodiment of the present invention.

### DESCRIPTION OF THE PREFERRED EMBODIMENTS

The invention will be now described herein with reference to illustrative embodiments. Those skilled in the art will recognize that many alternative embodiments can be accomplished using the teachings of the present invention and that the invention is not limited to the embodiments illustrated for explanatory purposes.

In the drawings, components identical to those therein are denoted with reference numerals with repeating explanation omitted for clarity. Embodiments hereinafter are WUSB communication system the present invention is applied thereto.

### First Embodiment

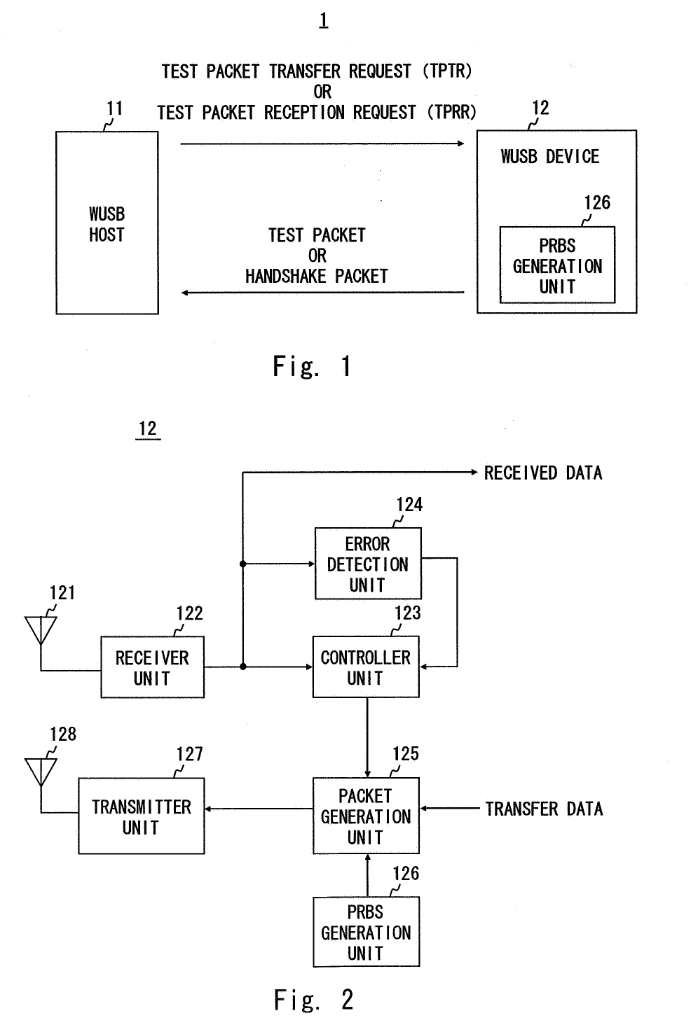

A configuration of a WUSB communication system 1 of this embodiment is shown in FIG. 1. The WUSB communication system 1 is configured by a WUSB host 11 and a WUSB device 12. Firstly an outline of a communication quality examination performed by the WUSB communication system 1 is described hereinafter in detail with reference to FIG. 1.

To examine communication quality of the IN direction from the WUSB device 12 to the WUSB host 11, the WUSB host 11 sends a test packet transfer request to the WUSB device 12 in a token phase of a WUSB transaction. The WUSB device 12 that successfully received the test packet transfer request generates one packet of a data packet (hereinafter referred to as a test packet). Then the WUSB device 12 sends the generated test packet to the WUSB host 11 in a data phase of the WUSB transaction. The WUSB host verifies whether a digital error exists in a data transfer of the IN direction by a FCS of the test packet received from the WUSB device 12. The WUSB host 11 is able to determine whether an error is generated at a reception by the existence of the digital error.

A PRBS generated by a PRBS generation unit 126 is stored to a payload of the test packet generated by the WUSB device 12. Further, the FCS for detecting at least one bit digital error generated in the payload is appended to the test packet as data for error check. Specifically, a CRC (Cyclic Redundancy Check) calculated value generated by a CRC calculation is appended to the test packet as the FCS.

On the other hand, to examine communication quality of the OUT direction from the WUSB host 11 to the WUSB host 12, the WUSB host 11 sends a test packet reception request to the WUSB device 12 in the token phase of the WUSB transaction. Further, in the data phase following the token phase, the test packet is transferred from the WUSB host 11 to the WUSB device 12.

The WUSB device 12 that has received the test packet verifies whether the digital error exists by referring to the FCS (Frame Check Sequence) appended to the test packet. If not detecting the digital error, the WUSB device 12 notifies a successful reception of the test packet to the WUSB host 11 by a handshake packet that is sent in a handshake phase.

On the other hand if detecting the digital error by referring to the FCS, the WUSB device 12 notifies an unsuccessful reception of the test packet to the WUSB host 11 by a handshake packet that is sent in the handshake phase.

The handshake packet sent from the WUSB device 12 to the WUSB host 12 includes an ACK code of a bit map format indicating a reception result of the data packet. The WUSB host 11 verifies whether the digital error exists in the data transfer of the OUT direction by referring to the handshake packet received from the WUSB device 12.

The WUSB host 11 determines parameters including a maximum packet length, a maximum number of bursts, a bit rate of transfer data, and transmit power of a WUSB packet transferred between the WUSB host 11 and the WUSB device 12, using at least one of the results of the communication quality examinations of the OUT and IN directions. For example if a rate of the digital error exceeds a certain target value, processes are performed such as reducing the maximum packet length, the bit rate, and the maximum number of burst, and increasing the transmit power.

Even in a case there is no problem in the communication quality between the WUSB host 11 and the WUSB device 12, appropriate parameters can be determined in order to increase an efficiency of the bandwidth of communication band currently used. To be more specific, an acceptable value of the digital error rate is specified to the WUSB host 11, and the bit rate of transfer data of the WUSB device 12 is increased to examine communication quality. The digital error rate at an increased bit rate is estimated, so as to determine whether to employ the bit rate depending if the estimated digital error rate is less than or equal to the specified allowable value. Furthermore, by repeating the communication quality examination with various bit rates of the transfer data of the WUSB device 12, a maximum bit rate allowable can be determined.

The parameters determined by the WUSB host 11 are notified from the WUSB host 11 to the WUSB device 12 as a data transfer condition between the WUSB host 11 and the WUSB device 12.

A configuration of the WUSB device 12 is described hereinafter in detail with reference to FIG. 2. FIG. 2 is a block diagram illustrating the configuration of the WUSB device 12. A receiver unit 122 demodulates a signal received via an antenna 121. A controller unit 123 evaluates a type of the request notified by the WUSB host 11 by referring to a control packet included in the received data demodulated by the receiver unit 122. The controller unit 123 performs a control according to the evaluated type of request.

An error detection unit 124 detects the digital error of the data packet by referring to the FCS appended to the data packet received from the WUSB 11.

A packet generation unit 125 generates WUSB packets such as the data packet, and the handshake packet. The packet generation unit 125 generates the test packet with a payload having the PRBS generated by the PRBS generation unit 126 according to a direction by the controller unit 123.

The PRBS generation unit 126 generates the PRBS used as the test data in the examination of communication quality in the IN direction.

A transmitter unit 127 maps the WUSB packet generated by the packet generation unit 125 to a superframe of a unit of 65 ms, adds a PHY header to the superframe, modulates the superframe, and sends to the WUSB host 11 via an antenna 128.

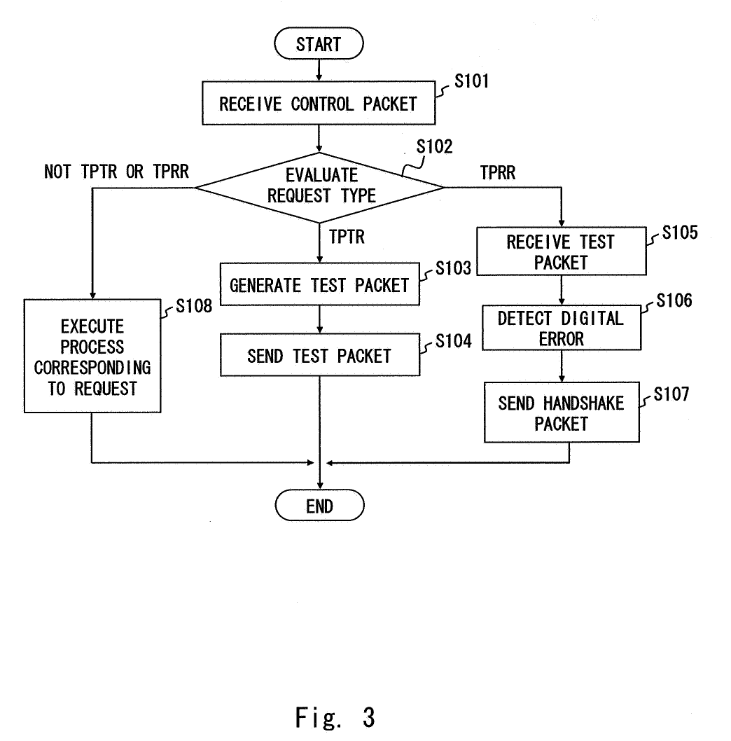

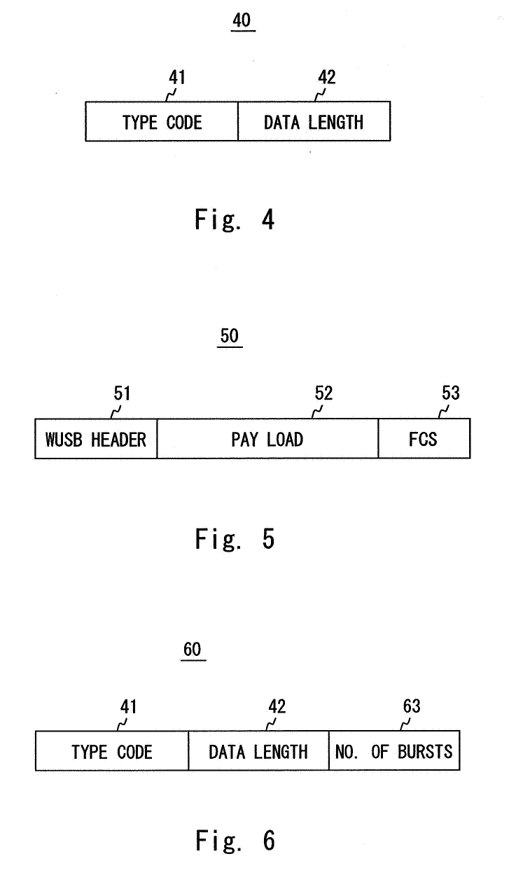

An operation of the WUSB device 12 that has received the request from the WUSB host 11 is described hereinafter in detail with reference to FIG. 3. In step S101, the controller unit 123 receives the control packet. The controller unit 123 refers to the control packet to evaluate the type of the request received from the WUSB host 11 (step S102). Specifically, since a code (hereinafter referred to as a type code) corresponding to the request type is provided to the request received from the WUSB host 11, the controller unit 123 evaluates the request type by the type code. An example of a format of the test packet transfer request is shown in FIG. 4. A test packet transfer request 40 includes at least a type code 41 and a data length 42. The data length 42 is information indicating a length of the test data to be sent to the WUSB host 11. A format of the test packet reception request is same as the format of the test packet transfer request of FIG. 4.

In the evaluation of step S102, if the request from the WUSB host 11 is the test packet transfer request (TPTR), the controller unit 123 directs the packet generation unit 125 to generate the test packet with a payload having test data with the data length specified by the test packet transfer request. The packet generation unit 125 generates the test packet with the payload of the pseudo random bit sequence generated by the PRBS generation unit 126 (step S103). The test packet generated by the packet generation unit 125 is sent to the WUSB host 11 by the transmitter unit 127 (step S104). A format of a data packet 50 generated by the packet generation unit 125 is shown in FIG. 5. A header 51 is header information specified in the WUSB specification, including an end point number for identifying an end point of a source and a packet ID etc. Length of a payload 52 is variable. A payload length of the data packet to be generated if the data packet is the test packet is determined according to the data length included in the test packet transfer request 40. A FCS 53 is a code for detecting a digital error such as the CRC value calculated for the payload 52.

If the request from the WUSB host 11 is turned out to be the transfer packet reception request (TPRR) in the evaluation of step S102, the error detection unit 124 detects a digital error occurred in the test packet received following the control packet (steps S105 and S106).

A result of the detection of the digital error by the error detection unit 124 is input to the controller unit 123. The controller unit 123 directs the packet generation unit 125 to generate the handshake packet corresponding to the detection result of the digital error by the error detection unit 124. The packet generation unit 125 generates the. handshake packet indicating whether the digital error exists by the ACK code. The handshake packet generated by the packet generation unit 125 is sent to the WUSB host 11 via the transmitter unit 127 and the antenna 128 (step S107).

If the request from the WUSB host 11 is neither the test packet transfer request (TPTR) nor the test packet reception request (TPRR), a process responding to the request is executed (step S108). This process is same as the process performed by the conventional WUSB device 12. The explanation will not be repeated here.

As described in the foregoing, in the WUSB communication system 1 of this embodiment, the WUSB device 12 generates the test packet in response to the test packet transfer request from the WUSB host 11, and the communication quality examination of the IN direction is performed by sending the test packet to the WUSB host 11.

In the conventional WUSB communication system complying with the WUSB specification, to examine communication quality of the IN direction, the test data to be sent from the WUSB device to the WUSB host needs to be sent from the WUSB host to the WUSB device by the loopback data write request. On the other hand in the WUSB communication system 1 of this embodiment, the WUSB device 12 itself generates the test data, thus it is not necessary for the WUSB host 11 to provide the test data to the WUSB device 12. Accordingly the WUSB communication system 1 is able to suppress generating a redundant generation because the WUSB host provides the test data to the WUSB device, as compared to the conventional WUSB communication system complying with the WUSB specification.

Further, the WUSB device 12 generates the data packet with the payload of pseudo random bit sequence generated by the PRBS generation unit 126. The conventional WUSB device complying with the WUSB specification requires a memory for storing the test data received from the WUSB host by the loopback data write request. Further the memory needs to have a capacity storable of 3584 bytes data, which is a maximum payload length of the WUSB packet. On the other hand the WUSB device 12 of this embodiment is not required to receive the test data from the WUSB host 11 to store it, because the pseudo random bit sequence generated by the PRBS generation unit 126 is to be the test data. This eliminates the need for the WUSB device 12 to have the memory for storing the test data, thereby reducing a circuit size as compared to the conventional WUSB device.

The loopback data read request specified in the WUSB specification may be used for the test packet transfer request sent from the WUSB host 11 to the WUSB device 12, or a new request may be defined. The request may be transferred to an end point other than a default end point (end point 0) for transferring a control that is defined to receive the request, or to an end point for bulk transfer.

Similarly, the loopback data write request specified in the WUSB specification may be used for the test packet reception request sent from the WUSB host 11 to the WUSB device 12 or a new request may be defined. Even in a case of using the loopback data request, the test data received from the WUSB host 11 needs not to be stored to the memory.

### Second Embodiment

This embodiment is the WUSB device 12 of the first embodiment of the present invention extended to generate a plurality of test packets in response to one test packet transfer request and to consecutively send the test packets.

In this embodiment, a test packet transfer request 60 employing a format shown in FIG. 6 is used instead of the format of the test packet transfer request shown in FIG. 4. The test packet transfer request 60 of FIG. 6 is the test packet transfer request 40 added with the number of bursts 63. The number of bursts 63 is information indicating the number of test packets to be consecutively sent from the WUSB device 12, which received the test packet transfer request 60.

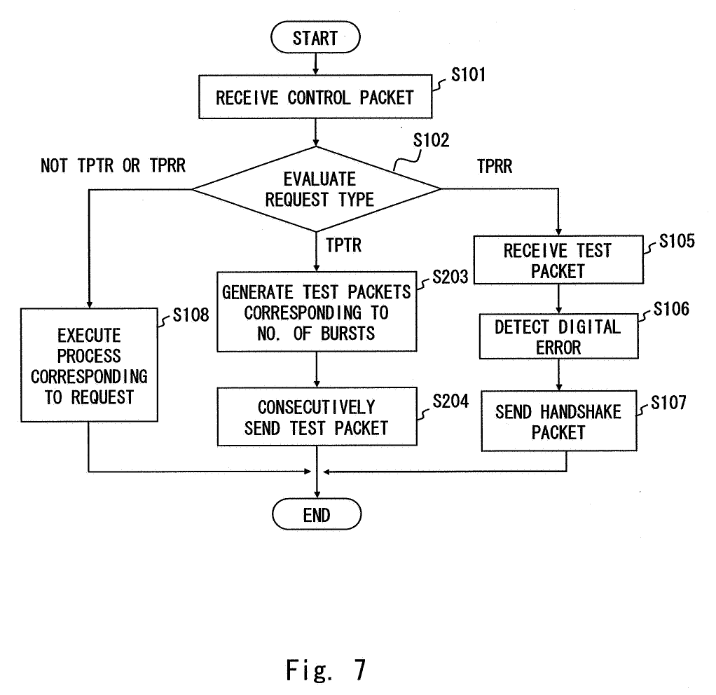

An operation of the WUSB device 12 that received the test packet transfer request of FIG. 6 is described hereinafter in detail. FIG. 7 is a flowchart illustrating the operation of WUSB 12 of FIG. 3 extended to illustrate this embodiment. Steps in FIG. 7 identical to those in FIG. 3 are denoted by reference numerals identical to those therein with detailed description omitted.

If the request from the WUSB host 11 is turned out to be the test packet transfer request (TPTR) in the evaluation of step S102, the controller unit 123 outputs the data length and the number of bursts specified by the test packet transfer request to the packet generation unit 125. The packet generation unit 125 generates test packets with payloads of pseudo random bit sequences having the data length specified by the test packet transfer request for the number of the bursts specified by the test packet transfer request (S203) The plurality of test packets generated by the packet generation unit 125 are consecutively sent to the WUSB 11 by the transmitter unit 127 (S204). To be more specific, the plurality of test data are sent in the data phase of one transaction group.

By sending the plurality of test packets in response to one test packet transfer request as described in the foregoing, it is possible to check burst dependence of the communication quality in the burst mode. This enables an accurate adjustment of the parameters such as the maximum number of bursts that are specific to the burst mode. The number of bursts determined by the WUSB host 11 is notified from the WUSB host 11 to the WUSB device 12 as one of the data transfer conditions between the WUSB host 11 and the WUSB device 12.

In the WUSB communication system, the burst mode is generally used in a real-time transfer of audio and image data. In this case, without a communication control for securing necessary communication quality, it is difficult to transfer audio and image data real-time. In the WUSB communication system of this embodiment, the examination for the burst dependence of the communication quality is performed by a burst transfer of the test packet. Accordingly the communication quality in the burst mode can accurately be evaluated.

### Other Embodiment

In the first and the second embodiments, the test packet with the payload of the pseudo random bit sequence generated by the PRBS generation unit 126 are generated. However the test data included in the payload of the test packet is not limited to the pseudo random bit sequence but may be any bit sequence. Accordingly a test data generation circuit for generating other test data may be mounted instead of the PRBS generation unit 126 for generating the pseudo random bit sequence. However to accurately estimate the rate of digital error, a bit sequence with better randomness should preferably be the test data.

In the first and the second embodiments of the present invention, the data for error check included in the test packet is to be the CRC value. However instead of the CRC value, it maybe other redundant data that can defect at least 1 bit digital error occurred in the payload.

The present invention is not limited to WUSB communication system, but may be applied to other communication systems for examining communication quality between two opposing communication apparatuses by one of the communication apparatus sending the test data to another.

It is apparent that the present invention is not limited to the above embodiment and it may be modified and changed without departing from the scope and spirit of the invention.

What is claimed is:

1. A communication system comprising:
(a) a first communication apparatus including:
(i) a test data generation unit being configured to generate test data;
(ii) a packet generation unit being configured to generate a test packet having a payload and an error check data in response to a test packet transfer request, the payload containing the test data generated by the test data generation unit, the error check data being used to detecting a digital error occurred in the payload; and
(iii) a transmitter unit being configured to send the test packet; and
(b) a second communication apparatus being configured to send the test packet transfer request to the first communication apparatus, and to verify quality of the test packet received from the first communication apparatus according to the error check data.

2. The communication system according to claim 1, wherein the test data is a pseudo random bit sequence.

3. The communication system according to claim 1, wherein the second communication apparatus determines a data transfer condition of the first communication apparatus according to a result of the quality verification of the test packet and notifies the determined data transfer condition to the first communication apparatus.

4. The communication system according to claim 1, wherein the test packet transfer request includes information indicating a packet length of the test packet and the number of the test packet transfers, and
the first communication apparatus consecutively sends a plurality of the test packet in response to one of the test packet transfer request.

5. The communication system according to claim 4, wherein the second communication apparatus determines the data transfer condition of the first communication apparatus according to the result of the quality verification of the test packet and notifies the determined data transfer condition to the first communication apparatus, and
the data transfer condition includes a maximum number of packets that the first communication apparatus is able to consecutively send.

6. The communication system according to claim 1, wherein the second communication apparatus evaluates an increase of bit rate for sending data by the first communication apparatus according to a transfer rate of the test packet by the communication apparatus and the result of the quality verification of the test packet.

7. The communication system according to claim 1, wherein the first communication apparatus is a wireless USB device, and the second communication apparatus is a wireless USB host.

8. The communication system according to claim 4, wherein the first communication apparatus is a wireless USB device, and the second communication apparatus is a wireless USB host.

9. A communication apparatus comprising:
a test data generation unit being configured to generate test data;
a packet generation unit being configured to generate a test packet having a payload and an error check data in response to a test packet transfer request received from an opposing communication apparatus, the payload containing the test data generated by the test data generation unit, the error check data being used to detecting a digital error occurred in the payload; and
a transmitter unit for sending the test packet to the opposing communication apparatus.

10. The communication apparatus according to claim 9, wherein the test data is a pseudo random bit sequence.

11. The communication apparatus according to claim 9, wherein the test packet transfer request includes information indicating a packet length of the test packet and the number of the test packet transfers, and
the communication apparatus consecutively sends a plurality of the test packets in response to one of the test packet transfer request.

12. The communication apparatus according to claim 9, wherein the communication apparatus detects whether a digital error exists in the test packet received from the opposing communication apparatus and sends a result of the detection to the opposing communication apparatus.

13. The communication apparatus according to claim 9, further comprising:
a receiver unit being configured to receive a packet sent from the opposing communication apparatus; and
a controller unit being configured to analyze the packet received by the receiver unit and to request the packet generation unit to generate the test packet once detected the test packet transfer request.

14. A method for examining communication quality between a first communication apparatus having a test data generation unit configured to generate test data and a second communication apparatus configured to send and receive data with the first communication apparatus, the method comprising:
the second communication apparatus sending a test packet transfer request to the first communication apparatus;
the first communication apparatus sending a test packet to the second communication apparatus according to the test packet transfer request, the test packet having a payload including the test data generated by the test data generation unit and the test packet having error check data detectable of a digital error occurred in the payload; and
the second communication apparatus verifying whether a digital error exists in the received test packet according to the error check data.

15. The method according to claim 14, wherein the second communication apparatus determines a data transfer condition of the first communication apparatus according to a result of the verification of the test packet, and notifies the determined data transfer condition to the first communication apparatus.

16. The method according to claim 14, wherein the test packet transfer request includes information indicating a packet length of the test packet and the number of transfers of the test packet, and
the first communication apparatus consecutively sends a plurality of the test packets in response to one test packet transfer request.

17. The method according to claim 14, wherein the test data is a pseudo random bit sequence.
